(19) United States
(12) Patent Application Publication
(10) Pub. No.: US 2026/0175838 A1
(43) Pub. Date: Jun. 25, 2026

(54) SCENARIO-DEPENDENT ADAPTIVE SPEED CONTROL

(71) Applicant: Valeo Schalter und Sensoren GmbH, Bietigheim-Bissingen (DE)

(72) Inventors: Ivan Surovtcev, Bietigheim-Bissingen (DE); Gerald Koudijs, Bietigheim-Bissingen (DE)

(73) Assignee: Valeo Schalter und Sensoren GmbH, Bietigheim-Bissingen (DE)

(21) Appl. No.: 19/126,450

(22) PCT Filed: Oct. 25, 2023
(86) PCT No.: PCT/EP2023/079708

§ 371 Date: May 1, 2025

(30) Foreign Application Priority Data
Nov. 3, 2022 (DE) 10 2022 129 010.7

(51) Int. Cl. B60W 30/14; B60W 10/08; B60W 10/18; B60W 40/13

(52) U.S. Cl. CPC B60W 30/143; B60W 10/08; B60W 10/18; B60W 40/13; B60W 2530/10; B60W 2552/15; B60W 2554/20

(57) ABSTRACT

A method for adaptive speed control of a motor vehicle. The method includes carrying out a mass estimation in order to determine a value range for a mass of the motor vehicle, selecting a mass value within the value range based on a current driving scenario of the motor vehicle, and generating a torque request for performing the adaptive speed control based on the mass value and based on at least one target specification.

The present invention relates to a method for adaptive speed control of a motor vehicle, a driver assistance system for adaptive speed control of a motor vehicle, and a computer program product.

Driver assistance systems for adaptive speed control of a motor vehicle, also referred to as adaptive cruise controls or ACC, are known. A further motor vehicle driving in front of a motor vehicle can be detected by means of a surroundings sensor system, such as a camera, a lidar system, and/or a radar system, and its distance to the motor vehicle and also its speed can be determined. Torque requirements can be generated as a function thereof, based on which a drive motor and/or a braking system of the motor vehicle are actuated to achieve a target specification. The speed of the motor vehicle can thus be regulated to a predetermined target speed, for example, if a predetermined minimum distance to the further motor vehicle can be maintained; otherwise the speed of the motor vehicle is reduced, for example.

To determine the required torque, it is necessary to determine the total mass of the motor vehicle at least approximately. The empty mass of the motor vehicle could be used as the basis for a rough estimation. Due to the additional weight of passengers and possibly cargo, however, this estimation would be very inaccurate, which could result in unreliable speed control or a safety risk. Therefore, the mass of the vehicle can be estimated in its operation based on measured or estimated values relating to the vehicle dynamics, for example, in that the applied torque is related to the resulting speed change, thus acceleration or deceleration, of the motor vehicle.

Document US 2013/0138288 A1 describes a vehicle system and a method, which estimates the mass of a vehicle so that a more accurate estimation of the vehicle mass can be provided to other vehicle systems, for example, an adaptive speed control system or an automatic lane change system. An actual acceleration of the vehicle is compared to an expected acceleration here. The difference between these two acceleration values can then be used together with the torque to estimate the actual mass of the vehicle.

Document US 2019/0171225 A1 describes systems, methods, controllers, and algorithms for the control of a vehicle, in order to follow another vehicle using automatic or semiautomatic control. A mass estimator is used here, which determines the mass of the vehicle based on the motor or braking torque used.

However, it is unavoidable that uncertainties will occur in the determination of the mass, which has the result that in general the exact mass cannot be determined, but rather only a corresponding value range within which the mass according to the corresponding measurement and/or estimation lies. For safety reasons, the torque request can be based on the most conservative possible value for the mass, which reduces the performance of the adaptive cruise control, however, since therefore the performance of the drive motor or the braking system is not completely exhausted.

It is an object of the present invention to increase the performance of an adaptive speed control of a motor vehicle without having to accept an increased safety risk in this case.

This object is achieved by the respective subject matter of the independent claims. Advantageous refinements and preferred embodiments are the subject matter of the dependent claims.

The invention is based on the concept that the mass value on which the torque request is based is selected depending on a driving scenario in which the motor vehicle is located from a value range for the mass of the motor vehicle determined by a mass estimation.

A method for adaptive speed control of a motor vehicle is specified according to the invention. A mass estimation is carried out here, in particular by means of at least one control unit of the motor vehicle, to determine a value range for a mass of the motor vehicle. A mass value within the value range is selected depending on a driving scenario in which the motor vehicle is located, in particular by means of the at least one control unit. Depending on the mass value and depending on a target specification, which relates to a target speed of the motor vehicle and/or a target safety distance of the motor vehicle, a torque request for the adaptive speed control is generated, in particular by means of the at least one control unit.

A control unit can also be referred to as a computing unit. For example, the at least one control unit can be implemented by at least one electronic control unit (ECU). A computing unit can be understood, in particular, to be a data processing apparatus which contains a processing circuit. The computing unit can therefore process data in particular for carrying out computing operations. Optionally, these also include operations for performing indexed accesses to a data structure, for example a look-up table (LUT).

The computing unit can in particular contain one or more computers, one or more microcontrollers, and/or one or more integrated circuits, for example one or more application-specific integrated circuits (ASIC), one or more field-programmable gate arrays (FPGA), and/or one or more systems-on-a-chip (SoC). The computing unit can also contain one or more processors, for example one or more microprocessors, one or more central processing units (CPU), one or more graphics processing units (GPU), and/or one or more signal processors, in particular one or more digital signal processors (DSP). The computing unit may also contain a physical or virtual group of computers or other types of the mentioned units.

In various exemplary embodiments, the computing unit contains one or more hardware and/or software interfaces and/or one or more storage units.

A storage unit can be configured as a volatile data memory, for example as a dynamic random access memory (DRAM) or a static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random-access memory (MRAM), or as a phase-change random-access memory (PCRAM).

The mass of the motor vehicle corresponds here and hereinafter in particular to a total mass of the motor vehicle including the empty mass of the motor vehicle, the mass of all passengers, possibly the mass of a fuel, and possibly other cargo.

The torque request can include, for example, a torque value, thus in particular an absolute value and a sign, of a torque, which is to be generated according to the adaptive speed control by a drivetrain, in particular a drive motor, of the motor vehicle and/or a braking system of the motor vehicle. The torque value is calculated here in particular depending on the mass value, depending on the target specification, and possibly depending on further data, in particular surroundings sensor data of the surroundings of the motor vehicle and/or status data of the motor vehicle.

Depending on the torque request, a drive motor of the motor vehicle and/or the braking system of the motor vehicle is thus in particular actuated, in particular by means of the at least one control unit, so that a torque is generated according to the torque request. In particular the drive motor is used for acceleration and the braking system is used for deceleration here. However, the motor braking effect of the drive motor can also deliberately be used for deceleration, in particular in the case of an electric motor.

The target specification can include, for example, the target speed and the target safety distance. The target speed can be predetermined here, for example, by a driver of the motor vehicle. The target safety distance corresponds in particular to a distance of the motor vehicle from a further road user located in front of the motor vehicle in the direction of travel of the motor vehicle, in particular a further motor vehicle, wherein the further road user is not necessarily present when the method according to the invention is carried out, however. The distance of the motor vehicle can possibly be determined by means of a surroundings sensor system of the motor vehicle, for example, a lidar system, a radar system, and/or a camera system of the motor vehicle. If a camera system is used, the distance can be estimated by a corresponding algorithm for depth estimation or the like. The torque request is thus in particular generated such that when it is implemented by generating the corresponding torque, the target safety distance is maintained or attempted and the speed of the motor vehicle is regulated to the target speed, if this can be unified with maintaining the target safety distance. Otherwise, the speed of the motor vehicle is reduced accordingly, for example, to a maximum speed at which the target safety distance can be maintained. The target safety distance can depend on the speed of the motor vehicle. It can be decreased or increased by a user input in a predetermined scope, for example.

The calculation of the torque value as such is known from known driver assistance systems for adaptive speed control. According to the invention, however, the mass value is selected from the value range depending on the driving scenario. The value range results from the mass estimation. For example, the mass estimation supplies a measured value or estimated value for the mass and an uncertainty of the mass estimation, quantified by a variance of the mass, for example. The value range can then be given, for example, by the measured value or estimated value to which the uncertainty is applied. Alternatively, a, relative or absolute, permanently predetermined tolerance range can also be applied to the measured value or estimated value in order to obtain the value range.

Due to the selection of the mass value, which is used to generate the torque request, depending on the driving scenario, the entire value range can be utilized depending on the situation, so that, for example, a greater mass value can be used as the basis if a particularly reliable reduction of the speed, in particular for safety reasons, is required according to the driving scenario. This can be the case, for example, in a driving scenario in which a further motor vehicle which is stationary or is driving much slower is located in front of the motor vehicle or in the case of assisted emergency braking, for example, when a pedestrian is located stationary or at low speed in front of the motor vehicle. In other driving scenarios, for example, a higher mass value can be used to ensure the highest possible acceleration, for example, when the driving scenario corresponds to a passing maneuver or lane change of the motor vehicle, or a lower mass value to achieve a more conservative acceleration.

According to at least one embodiment of the method, surroundings sensor data, which represent the surroundings of the motor vehicle located in front of the motor vehicle, are generated, in particular by means of a surroundings sensor system of the motor vehicle. The torque request is generated depending on the surroundings sensor data. In particular, the torque requested according to the torque request is calculated depending on the surroundings sensor data.

The surroundings sensor system includes, for example, one or more cameras, one or more lidar systems, and/or one or more radar systems of the motor vehicle. The at least one control unit can recognize based on the surroundings sensor data whether the further road user is located in front of the motor vehicle, in particular within a detection range of the surroundings sensor system and, if this is the case, can determine the distance of the motor vehicle from the further road user. The distance can be determined directly from the surroundings sensor data, for example, in the case of a radar system or lidar system, or indirectly, for example, in the case of a camera, for example, using one or more algorithms for image processing and/or for computer vision.

The torque request can then be generated depending on the finding as to whether the further road user is located in front of the motor vehicle or not, and possibly depending on the distance.

According to at least one embodiment, status data of the motor vehicle are determined, in particular by means of at least one status sensor of the motor vehicle. The torque request is generated depending on the status data. In particular, the torque requested according to the torque request is calculated depending on the status data.

The status data include in particular a current speed and/or current acceleration and/or a current rotational speed of the drive motor and/or a currently applied torque of the drive motor and/or a currently applied braking torque of the braking system. The at least one status sensor accordingly includes sensors for determining the mentioned variables.

Alternatively to the determination of the status data by means of the at least one status sensor, the status data can be provided as estimated status data, for example, by means of a motor control unit or brake control unit of the motor vehicle.

According to at least one embodiment, a slope of a roadway on which the motor vehicle is located is determined depending on predetermined digital map data, in particular by means of the at least one control unit, and the torque request is generated depending on the slope. In particular, the torque requested according to the torque request is calculated depending on the slope.

The slope can be a current or upcoming, in particular immediately upcoming, slope. The at least one control unit can in particular store the digital map data or receive them from a vehicle-external computing unit, such as a server computer, through a corresponding communication network, in particular a radio network.

According to at least one embodiment, an upcoming lane course of the roadway is determined depending on predetermined digital map data, in particular by means of the at least one control unit, and the torque request is generated depending on the lane course. In particular, the torque requested according to the torque request is calculated depending on the lane course.

Due to the consideration of the slope and/or the lane course, the torque request can be adapted even better to the current situation, for example, in that a higher torque for acceleration or a lower braking torque is requested, the higher the slope is, in case of a positive slope, and vice versa.

Alternatively or additionally to the consideration of the slope and/or the lane course in the calculation of the requested torque, the slope and/or the lane course can also be taken into consideration in the determination of the driving scenario. Accordingly, for example, in the case of a greater positive slope, a greater mass value can be selected from the value range than in the case of a smaller positive slope, for example, if the driving scenario requires a reliable acceleration of the vehicle. In contrast, if a particularly effective deceleration is in the foreground in the driving scenario, a smaller mass value can be selected from the value range in the case of a greater positive slope than in the case of a smaller positive slope. This can be transferred analogously to negative slopes. Accordingly, a smaller mass value can be used in the case of a lane course which corresponds to cornering than in the case of driving straight ahead.

According to at least one embodiment, the driving scenario is selected from a plurality of predetermined scenarios depending on the surroundings sensor data and/or depending on the status data of the motor vehicle.

In particular, the at least one control unit can determine a position of the further motor vehicle, for example, with respect to the motor vehicle, thus in particular the distance of the motor vehicle from the further motor vehicle and/or the speed of the further motor vehicle, in particular relative to the speed of the motor vehicle, depending on the surroundings sensor data. The at least one control unit can determine, for example, the speed of the motor vehicle and/or a steering activity and/or the presently requested torque based on the status data. Depending on the mentioned variables or parts thereof and/or further variables, the at least one control unit can identify the driving situation in which the motor vehicle is located as one of the plurality of predetermined scenarios and select accordingly. The selection can include, for example, that it is stored in computer-readable form which of the scenarios was identified.

For example, the plurality of predetermined scenarios can include a first scenario, in which it is established depending on the surroundings sensor data that a driving range of predefined length in front of the motor vehicle is free of further road users.

If the first scenario is selected, the torque request can thus be generated such that the speed of the motor vehicle is regulated to the target speed. A comparatively low first mass value within the value range is thus selected, for example, for the calculation of the requested torque.

For example, the plurality of predetermined scenarios can include a second scenario, in which the further motor vehicle located in front of the motor vehicle is identified depending on the surroundings sensor data, which moves at a speed, in particular a speed greater than zero, in the direction of travel of the motor vehicle, wherein the speed of the further motor vehicle is less than the speed of the motor vehicle. It is established depending on the status data of the motor vehicle that a lane change of the motor vehicle is not upcoming or has not been initiated.

The further motor vehicle, according to the surroundings sensor data, thus in particular drives on the same lane as the motor vehicle and the distance is decreasing. Accordingly, the torque request, if the second scenario is selected, can be generated such that the speed of the motor vehicle is reduced, in particular to a value which is less than the target speed. Thus, for example, a moderate or higher second mass value within the value range is selected for the calculation of the requested torque. The second mass value is in particular greater here than the first mass value in the hypothetical case that instead of the second scenario the first scenario had been identified.

For example, the second mass value can also be selected depending on the difference of the speed of the motor vehicle and the speed of the further motor vehicle, wherein the second mass value is in particular greater the greater the difference is. The level of safety can thus be increased, in that requesting an excessively low braking torque is avoided.

For example, the plurality of predetermined scenarios can include a third scenario, in which the further motor vehicle located in front of the motor vehicle is identified depending on the surroundings sensor data, and it is established depending on the status data of the motor vehicle that a lane change of the motor vehicle is upcoming or has been initiated.

The speed of the further motor vehicle is in particular less here than the speed of the motor vehicle. If the third scenario is selected, it is thus probable that a passing procedure is upcoming or has been initiated. In order to be able to carry this out as quickly as possible, a comparatively large third mass value can be selected, so that the resulting acceleration of the motor vehicle being less than intended is avoided. The third mass value is in particular greater here than the first mass value in the hypothetical case that instead of the second scenario, the first scenario had been identified and, for example, is greater than the second mass value in the hypothetical case that instead of the third scenario the second scenario had been identified.

For example, the plurality of predetermined scenarios can include a fourth scenario, in which a stationary object located in front of the motor vehicle, for example, a stationary vehicle, is identified depending on the surroundings sensor data and it is established depending on the status data of the motor vehicle that a lane change of the motor vehicle is not upcoming or has not been initiated.

Since no lane change is being carried out, the speed of the motor vehicle can be greatly reduced or the motor vehicle can be braked to a standstill. To be able to carry out the braking procedure as quickly and reliably as possible, a comparatively large fourth mass value can be selected, so that the resulting deceleration of the motor vehicle being less than intended is avoided. The fourth mass value is in particular greater here than the first mass value in the hypothetical case that instead of the second scenario the first scenario had been identified and, for example, is greater than the second mass value in the hypothetical case that instead of the fourth scenario the second scenario had been identified and, for example, is greater than the third mass value in the hypothetical case that instead of the fourth scenario the third scenario had been identified.

According to at least one embodiment, the mass estimation includes the respective measurement or estimation of at least one measured variable or estimated variable and the value range is determined depending on a measurement uncertainty or estimation uncertainty of the at least one measurement or estimation.

The at least one measured variable or estimated variable in particular includes a torque according to a further torque request and an acceleration or deceleration of the motor vehicle following the torque request.

According to at least one embodiment, the mass estimation is carried out using a Kalman filter algorithm and the value range is determined depending on a covariance matrix which is determined, in particular predicted, by means of the Kalman filter algorithm.

A status or status vector, which in the present case includes the mass of the motor vehicle, is determined cyclically according to the Kalman filter algorithm. The measured variables on which the Kalman filter algorithm is based include in particular the torque according to the further torque request and the acceleration or deceleration of the motor vehicle following the torque request.

According to the Kalman filter algorithm, for each cycle, in addition to the corresponding status or status vector, an associated covariance matrix is also determined, which is generally referred to in the formalism of the Kalman filter algorithm as the covariance P of the respective status. The process noise, typically designated by Q, and the measurement noise, typically designated by R, are incorporated, for example, inter alia, in the calculation of the covariance P.

According to at least one embodiment, the torque according to the torque request is generated by means of a drive motor of the motor vehicle and/or a braking system of the motor vehicle. For this purpose, the drive motor and/or the braking system are actuated in particular by the at least one control unit depending on the torque request.

For application cases or application situations which can result in the method and which are not explicitly described here, it can be intended that, according to the method, an error message and/or a request for input of user feedback is output and/or a default setting and/or a predetermined initial state is set.

According to a further aspect of the invention, a driver assistance system for adaptive speed control of a motor vehicle is specified. The driver assistance system has at least one control unit, which is configured to carry out a mass estimation in order to determine a value range for a mass of the motor vehicle, to select a mass value within the value range depending on a driving scenario in which the motor vehicle is located, and to generate a torque request for the adaptive speed control depending on the mass value and depending on a target specification, which relates to a target speed of the motor vehicle and/or a target safety distance of the motor vehicle.

According to at least one embodiment of the driver assistance system, the at least one control unit is configured to obtain a measurement result or estimation result of a respective measurement or estimation of at least one measured variable or estimated variable from a communication network of the motor vehicle and to carry out the mass estimation depending on the measurement result or estimation result.

The communication network, which can in particular be a communication bus system, such as a CAN bus, connects, for example, one or more sensors for detecting the at least one measured variable to the at least one control unit. In some embodiments, the one sensor or the multiple sensors can be part of the driver assistance system. The communication network can also connect a motor controller or brake controller to the at least one control unit in order to provide the at least one estimated variable or the estimation result to the at least one control unit.

According to at least one embodiment, the driver assistance system contains at least one surroundings sensor system for the motor vehicle, which is configured to generate surroundings sensor data, which represent the surroundings of the motor vehicle located in front of the motor vehicle, in particular when the surroundings sensor system is installed on the motor vehicle, and the at least one control unit is configured to generate the torque request depending on the surroundings sensor data.

According to at least one embodiment, the driver assistance system contains at least one status sensor for the motor vehicle, which is configured to determine status data of the motor vehicle, in particular when the at least one status sensor is installed in or on the motor vehicle, and the at least one control unit is configured to generate the torque request depending on the status data.

According to at least one embodiment, the at least one control unit is configured to determine a slope of a roadway, on which the motor vehicle is located, depending on predetermined digital map data, and to generate the torque request depending on the slope.

If the present disclosure refers to a component of the driver assistance system according to the invention, in particular the at least one control unit of the driver assistance system, as being designed, formed, configured, or the like, to execute or implement a certain function, to achieve a certain effect or to serve a certain purpose, this can be understood in such a way that the component, beyond the fundamental or theoretical usability or suitability of the component for this function, effect or purpose, is specifically and actually capable of executing or implementing the function, achieving the effect or serving the purpose by an appropriate adaptation, programming, physical configuration and so on.

Further embodiments of the driver assistance system according to the invention for adaptive speed control follow directly from the various designs of the method according to the invention for adaptive speed control and vice versa. In particular, individual features and corresponding explanations and advantages regarding the various embodiments relating to the method according to the invention can be transferred in an analogous manner to corresponding embodiments of the driver assistance system according to the invention. In particular, the driver assistance system according to the invention is designed or programmed to carry out a method according to the invention. In particular, the driver assistance system according to the invention carries out the method according to the invention.

According to a further aspect of the invention, a computer program having commands is specified. When the commands are executed by a driver assistance system according to the invention, in particular by the at least one control unit of the driver assistance system, the commands prompt the driver assistance system to carry out a method according to the invention.

According to a further aspect of the invention, a computer-readable storage medium is specified, which stores a computer program according to the invention.

The computer program and the computer-readable storage medium can be interpreted as respective computer program products having the commands.

Further features of the invention can be found in the claims, the figures, and the description of the figures. The features and combinations of features mentioned above in the description and the features and combinations of features mentioned below in the description of the figures and/or shown in the figures can be included in the invention not only in the combination specified in each case, but also in other combinations. In particular, embodiments and combinations of features that do not have all the features of an originally worded claim can also be included in the invention. Furthermore, embodiments and combinations of features that go beyond or differ from the combinations of features set out in the back-references of the claims can be included in the invention.

The invention is explained in more detail below on the basis of specific exemplary embodiments with reference to associated schematic drawings. In the figures, identical or functionally identical elements may be provided with the same reference signs. The description of identical or functionally identical elements may not necessarily be repeated with respect to different figures.

In the figures:

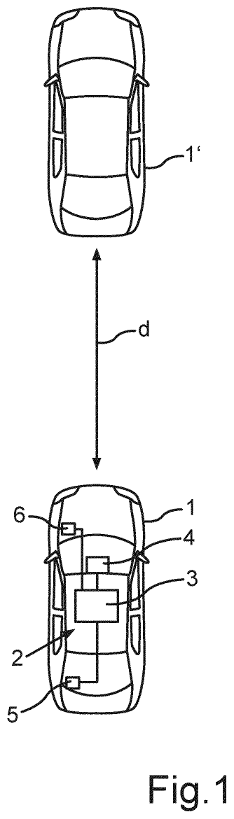

FIG. 1 shows a schematic representation of a motor vehicle having an exemplary embodiment of a driver assistance system according to the invention for adaptive speed control and a further motor vehicle;

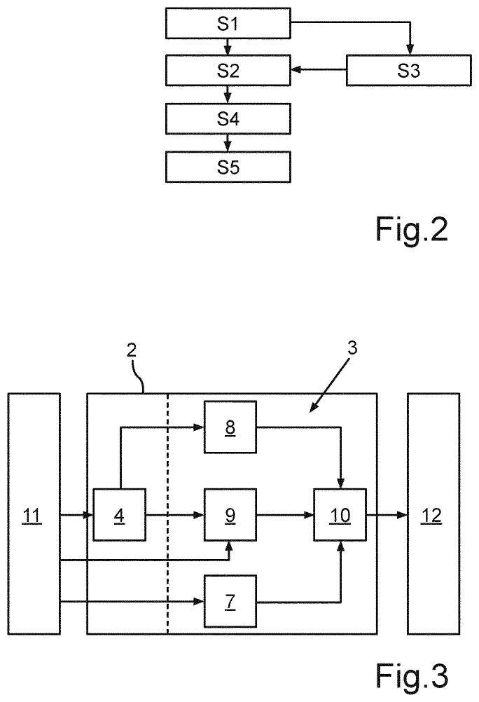

FIG. 2 shows a flow chart of an exemplary embodiment of a method according to the invention for adaptive speed control; and

FIG. 3 shows a schematic block diagram of a further exemplary embodiment of a driver assistance system according to the invention for adaptive speed control.

FIG. 1 schematically shows a motor vehicle 1, which has an exemplary embodiment of a driver assistance system 2 according to the invention for adaptive speed control. Furthermore, a further motor vehicle 1′ located in front of the motor vehicle 1, in particular driving on the same lane in the same direction, is shown at a distance d in front of the motor vehicle 1.

The driver assistance system 2 has at least one control unit 3, which, depending on the specific embodiment, can also be representative of two or more control units of the motor vehicle 1. The driver assistance system 2 can also have a surroundings sensor system 4, such as a camera, a lidar system, or a radar system, and/or one or more status sensors 5, 6, such as a torque sensor 5 and an acceleration sensor 6.

The driver assistance system 2 can in particular carry out a method according to the invention for adaptive speed control. A schematic flow chart of such a method in an exemplary embodiment is shown in FIG. 2.

In step S2, the control unit 3 carries out a mass estimation to determine a value range for a mass of the motor vehicle 1. The control unit 3 can base the mass estimation, for example, on status data of the motor vehicle 1, which are generated in step S1 by the status sensors 5, 6. In particular, the control unit 3 can use an applied torque measured by the torque sensor 5 and an acceleration or deceleration of the motor vehicle 1 resulting from the torque and measured by means of the acceleration sensor 6 in order to calculate or estimate the mass of the motor vehicle 1. Alternatively to the measurement of the torque by means of the torque sensor 5, the control unit 3 can receive an estimated applied torque, for example, from a motor controller or brake controller (not shown) of the motor vehicle 1.

In addition, in step S3, the control unit 3 can identify a driving scenario in which the motor vehicle 1 is located. For this purpose, the control unit 3 can use the status data and/or surroundings sensor data, which are generated in step S1 by the surroundings sensor system 4, and which represent the surroundings of the motor vehicle 1 located in front of the motor vehicle 1. The control unit 3 can recognize from the surroundings sensor data, for example, whether the further motor vehicle 1′ is present and possibly how large the distance d is.

In step S4, the control unit 3 selects a mass value within the value range depending on the driving scenario and generates, depending on the mass value and depending on a target specification, which relates to a target speed of the motor vehicle 1 and/or a target safety distance of the motor vehicle 1 from the further motor vehicle 1′, a torque request for the adaptive speed control. In step S5, the control unit 3 actuates a drive motor (not shown) and/or a braking system (not shown) of the motor vehicle 1, so that a torque is generated according to the torque request.

FIG. 3 is a block diagram of a further exemplary embodiment of the driver assistance system 2 according to the invention.

The driver assistance system 2 is connected via an input interface 11 to controllers of the drive motor and the braking system, so that the control unit 3 can receive the respective operating data, in particular the applied torque, therefrom. Furthermore, the driver assistance system 2 is connected via an output interface 12 with controllers of the drive motor and the braking system to the controllers of the drive motor and the braking system in order to transmit the torque request. The control unit 3 can also be connected to the status sensors 5, 6 via the input interface 11. The input interface 11 and the output interface 12 can also be implemented as a common input and output interface.

In the exemplary embodiment of FIG. 3, the control unit contains a scenario classifier module 8, which can identify the driving scenario as described, a mass estimation module 7, which can carry out the mass estimation as described, and a control module 10, which can select the mass value and generate the torque request as described. For example, the control unit 3 can also have a target selection module 9, which can detect and possibly track an object based on the surroundings sensor data, with respect to which object the adaptive speed control is to take place, in particular the further motor vehicle 1′.

As described, in particular with respect to the figures, the performance of the adaptive speed control is enhanced by the invention without an increased safety risk arising in this case.

1. A method for adaptive speed control of a motor vehicle, the method comprising:
carrying out a mass estimation to determine a value range for a mass of the motor vehicle;
selecting a mass value within the value range depending on a driving scenario in which the motor vehicle is located; and
generating a torque request for the adaptive speed control depending on the mass value and depending on at least one target specification,
wherein the at least one target specification comprises a target speed of the motor vehicle and/or a target safety distance of the motor vehicle.

2. The method as claimed in claim 1, further comprising:
generating surroundings sensor data, which represent the surroundings of the motor vehicle located in front of the motor vehicle, and the torque request is generated depending on the surroundings sensor data; and/or
determining status data of the motor vehicle, and the torque request is generated depending on the status data; and/or
determining a slope of a roadway, on which the motor vehicle is located, is depending on predetermined digital map data, and the torque request is generated depending on the slope; and/or
determining an upcoming lane course of the roadway depending on the predetermined digital map data and the torque request is generated depending on the lane course.

3. The method as claimed in claim 2, further comprising:
selecting the driving scenario depending on the surroundings sensor data and/or depending on the status data of the motor vehicle and/or the slope and/or the lane course from a plurality of predetermined scenarios.

4. The method as claimed in claim 3,
wherein the plurality of predetermined scenarios comprises a first scenario in which it is established depending on the surroundings sensor data that a driving range of predefined length in front of the motor vehicle is free of further road users.

5. The method as claimed in claim 3,
wherein the plurality of predetermined scenarios comprises a second scenario, in which, depending on the surroundings sensor data, a further motor vehicle located in front of the motor vehicle is identified, which moves at a speed in a direction of travel of the motor vehicle that is less than the speed of the motor vehicle and it is established depending on the status data of the motor vehicle that a lane change of the motor vehicle is not upcoming or has not been initiated.

6. The method as claimed in claim 3,
wherein the plurality of predetermined scenarios contains a third scenario, in which, depending on the surroundings sensor data, the further motor vehicle located in front of the motor vehicle is identified, and it is established, depending on the status data of the motor vehicle, that a lane change of the motor vehicle is upcoming or has been initiated.

7. The method as claimed in claim 3,
wherein the plurality of predetermined scenarios contains a fourth scenario, in which, depending on the surroundings sensor data, a stationary object located in front of the motor vehicle is identified and it is established depending on the status data of the motor vehicle that a lane change of the motor vehicle is not upcoming or has not been initiated.

8. The method as claimed in claim 1,
wherein the mass estimation includes the respective measurement of at least one measured variable and the value range is determined depending on a measurement uncertainty of the at least one measurement.

9. The method as claimed in claim 8,
wherein the respective measurement of the at least one measured variable includes a measurement of a generated torque for the speed control of the motor vehicle and a measurement of an acceleration or deceleration of the motor vehicle resulting from the generation of the torque.

10. The method as claimed in claim 1,
wherein the mass estimation is carried out using a Kalman filter algorithm and the value range is determined depending on a covariance matrix determined by the Kalman filter algorithm.

11. The method as claimed in claim 1, further comprising:
generating a torque according to the torque request by a drive motor of the motor vehicle and/or a braking system of the motor vehicle.

12. A driver assistance system for adaptive speed control of a motor vehicle, comprising at least one control unit, which is configured to:
to carry out a mass estimation in order to determine a value range for a mass of the motor vehicle;
to select a mass value within the value range depending on a driving scenario in which the motor vehicle is located; and
depending on the mass value and depending on at least one target specification, generate a torque request for the adaptive speed control,
wherein the at least one target specification comprises a target speed of the motor vehicle and/or a target safety distance of the motor vehicle.

13. The driver assistance system as claimed in claim 12, wherein the at least one control unit is configured to:
receive a measurement result of a respective measurement of at least one measured variable from a communication network of the motor vehicle; and
carry out the mass estimation depending on the measurement result.

14. The driver assistance system as claimed in claim 12, further comprising:
at least one surroundings sensor system for the motor vehicle, which is configured to generate surroundings sensor data which represent the surroundings of the motor vehicle located in front of the motor vehicle, and the at least one control unit is configured to generate the torque request depending on the surroundings sensor data; and/or
at least one status sensor for the motor vehicle, which is configured to determine status data of the motor vehicle, and the at least one control unit is configured to generate the torque request depending on the status data; and/or
wherein the at least one control unit is configured to determine a slope of a roadway, on which the motor vehicle is located, depending on predetermined digital map data, and to generate the torque request depending on the slope.

15. A non-transitory computer readable medium comprising a computer program product having commands which, upon execution by a driver assistance system as claimed in claim 12, prompt the driver assistance system to carry out a method for adaptive speed control of the motor vehicle, wherein the method comprises:
carrying out a mass estimation is carried out to determine a value range for a mass of the motor vehicle;
selecting a mass value within the value range is selected depending on a driving scenario in which the motor vehicle is located; and
generating a torque request for the adaptive speed control is generated depending on the mass value and depending on at least one target specification.
wherein the at least one target specification comprises a target speed of the motor vehicle and/or a target safety distance of the motor vehicle.
